(19) United States
(12) Patent Application Publication
(10) Pub. No.: US 2016/0048324 A1
(43) Pub. Date: Feb. 18, 2016

(54) ELECTRONIC DEVICE AND METHOD

(71) Applicant: KABUSHIKI KAISHA TOSHIBA

(72) Inventor: Kotaro FUKUI, Hamura Tokyo (JP)

(21) Appl. No.: 14/928,045

(22) Filed: Oct. 30, 2015

Related U.S. Application Data
(63) Continuation of application No. PCT/JP2013/065280, filed on May 31, 2013.

(51) Int. Cl. G06F 3/0488; G06F 17/21; G06T 11/20

(52) U.S. Cl. CPC G06F 3/04883; G06T 11/203; G06F 17/211

(57) ABSTRACT

According to one embodiment, an electronic device includes circuitry configured to display handwritten strokes on a screen, convert a first stroke of the strokes into a first shape pattern, the first stroke includes a first feature, and convert a second stroke of the strokes into a second shape pattern in accordance with the first shape pattern, the second stroke includes a second feature different from the first stroke and included in a range defined by the first stroke.

### CROSS REFERENCE TO RELATED APPLICATIONS

This application is a Continuation Application of PCT Application No. PCT/JP2013/065280, filed May 31, 2013, the entire contents of which are incorporated herein by reference.

### FIELD

Embodiments described herein relate generally to a technique processing a handwritten document.

### BACKGROUND

In recent years, various types of electronic devices such as tablets, PDAs and smart phones have been developed. Most of these devices comprise a touch screen display to allow the user to easily perform an input operation.

The user touches a menu or an object displayed on the touch screen display with a finger, etc. Thus, the user can instruct the electronic device to execute a function associated with the menu or the object. The user can prepare handwritten document data by handwriting characters, drawings or tables with a stylus or a finger on the touch screen display.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the external appearance of an electronic device according to an embodiment.

FIG. 2 shows an example of cooperative operations between the electronic device of the embodiment and external devices.

FIG. 3 shows an example of a document handwritten on a touch screen display of the electronic device according to the embodiment.

FIG. 4 shows an example of time-series data stored in a storage medium by the electronic device according to the embodiment.

FIG. 5 is an exemplary block diagram showing a system configuration of the electronic device according to the embodiment.

FIG. 6 shows an exemplary desktop screen displayed by the electronic device according to the embodiment.

FIG. 7 shows an exemplary display example of a setting screen of the electronic device according to the embodiment.

FIG. 8 shows a display example of a document formatting mode setting screen for setting a document formatting mode of the electronic device according to the embodiment.

FIG. 9 shows an example of a note preview screen displayed by the electronic device according to the embodiment.

FIG. 10 shows an example of a page edit screen displayed by the electronic device according to the embodiment.

FIG. 11 is an exemplary block diagram showing a configuration structure of a handwritten note application program executed by the electronic device according to the embodiment.

FIG. 12 is an exemplary flowchart showing steps of a document formatting process as a whole according to the embodiment.

FIG. 13 is an exemplary flowchart showing steps of a process performed when “Variable” is set according to the embodiment.

FIG. 14 is an exemplary flowchart showing steps of a process performed when “Fixed” is set according to the embodiment.

FIG. 15 is an exemplary flowchart showing steps of a process performed when “Hybrid 1” is set according to the embodiment.

FIG. 16 is an exemplary flowchart showing steps of a process performed when “Hybrid 2” is set according to the embodiment.

FIG. 17 shows an example of a screen on which a menu is displayed according to the embodiment.

FIG. 18 shows an example of a screen on which a menu is displayed according to the embodiment.

FIG. 19 shows an example of a circumscribed rectangle set for strokes of characters according to the embodiment.

FIG. 20 shows an example of a circumscribed rectangle set for strokes of a drawing according to the embodiment.

FIG. 21 shows an example of a circumscribed rectangle set for strokes of a table according to the embodiment.

FIG. 22 shows an example of a document formatted in a document formatting mode “variable” according to the embodiment.

FIG. 23 shows an example of a document formatted in a document formatting mode “Fixed” according to the embodiment.

FIG. 24 shows an example of a document formatted in a document formatting mode “Hybrid 1” according to the embodiment.

FIG. 25 shows an example of a document formatted in a document formatting mode “Hybrid 2” according to the embodiment.

### DETAILED DESCRIPTION

Various embodiments will be described hereinafter with reference to the accompanying drawings. In general, according to one embodiment, an electronic device includes circuitry configured to display handwritten strokes on a screen, convert a first stroke of the strokes into a first shape pattern, the first stroke comprising a first feature, and convert a second stroke of the strokes into a second shape pattern in accordance with the first shape pattern, the second stroke comprising a second feature different from the first stroke and included in a range defined by the first stroke.

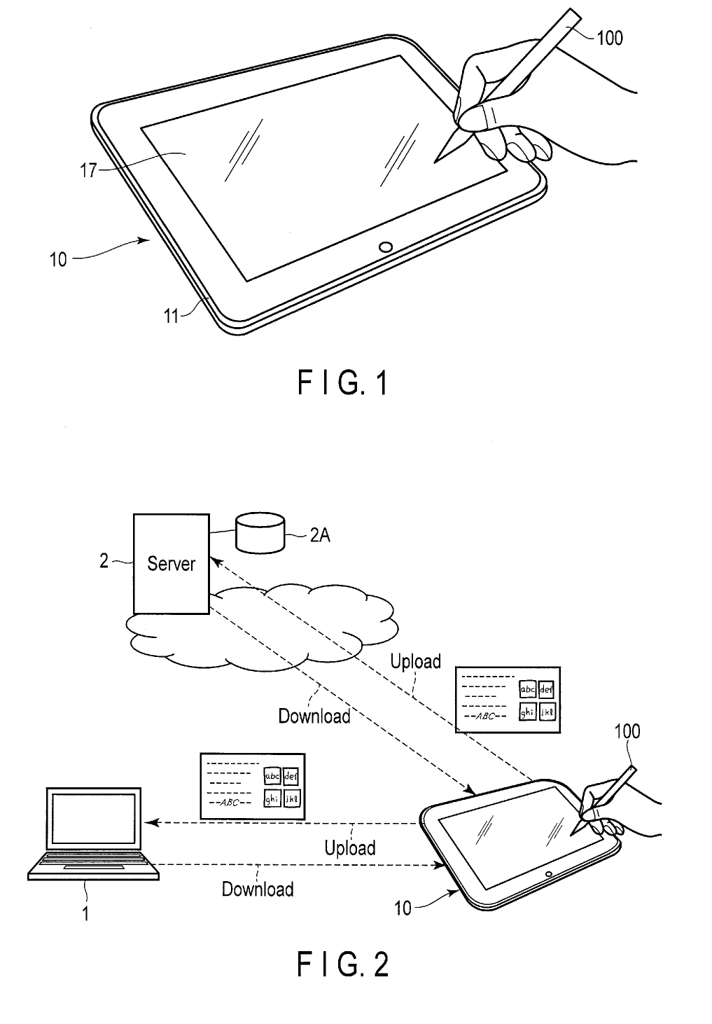

FIG. 1 is a perspective view showing the external appearance of an electronic device according to an embodiment. The electronic device is, for example, a stylus-based portable electronic device which enables the user to input data in handwriting with a stylus or a finger. The electronic device may be realized as, for example, a tablet computer, a notebook computer, a smart phone or a PDA. In the explanation below, it is assumed that the electronic device is realized as a tablet computer 10. The tablet computer 10 is a portable electronic device which is also called a tablet or a slate computer. As shown in FIG. 1, the tablet computer 10 comprises a main body 11 and a touch screen display 17. The touch screen display 17 is attached to the main body 11 so as to overlap the upper surface thereof.

The main body 11 comprises a housing having a thin-box shape. A flat-panel display and a sensor are incorporated into the touch screen display 17. The sensor is configured to detect the contact position of a stylus or a finger on the screen of the flat-panel display. The flat-panel display may be, for example, a liquid crystal display (LCD). For the sensor, for example, a capacitive touch panel or an electromagnetic induction type of digitizer may be used. In the explanation below, it is assumed that both of the two sensors, which are a digitizer and a touch panel, are incorporated into the touch screen display 17.

The touch screen display 17 is configured to detect a touch operation with a finger relative to the screen as well as a touch operation with a stylus 100 relative to the screen. The stylus 100 may be, for example, a digitizer stylus (electromagnetic induction type of stylus). The user can perform a handwriting input operation on the touch screen display 17, using the stylus 100. During the handwriting input operation, the path of movement of the stylus 100 on the screen is drawn in real time. In short, strokes handwritten by the handwriting input operation (or the paths of handwritten strokes) are drawn in real time. In this manner, a plurality of strokes input in handwriting are displayed on the screen. The path of movement of the stylus 100 in a contact period of the stylus 100 on the screen is equivalent to one stroke. The assembly of many strokes corresponding to handwritten characters, handwritten drawings and handwritten tables, etc., constitutes a handwritten document.

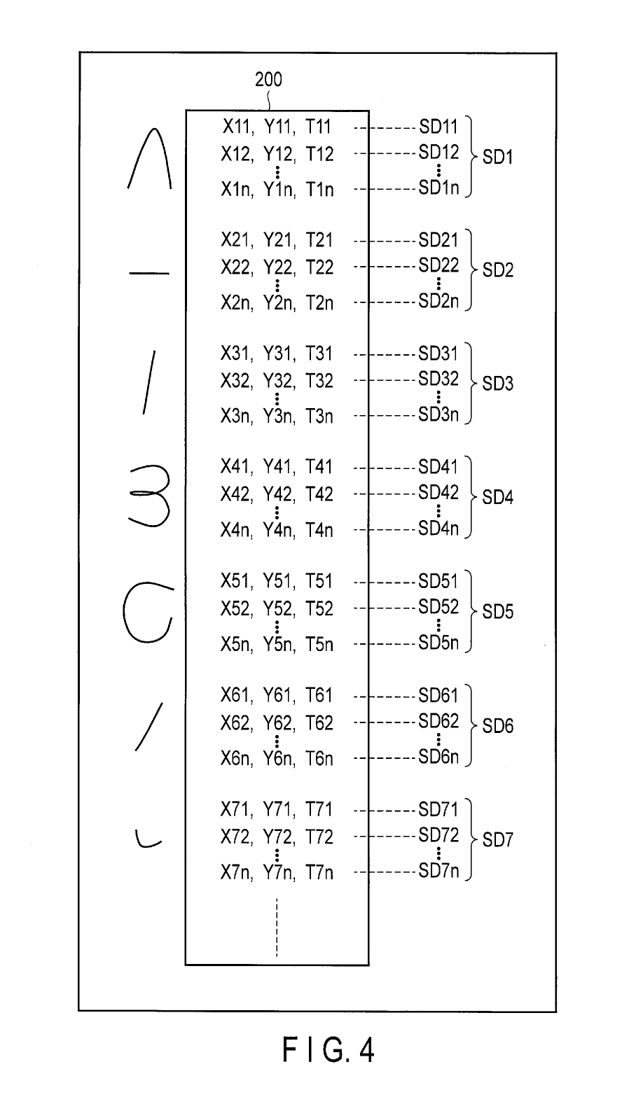

In the present embodiment, the handwritten document is not stored as image data. Instead, the handwritten document is stored in a storage medium as time-series data (handwritten document data) indicating a series of coordinates of the path of each stroke and the order relationships of strokes. The detail of time-series data is explained later with reference to FIG. 4. Briefly speaking, time-series data indicates the order in which a plurality of strokes are handwritten, and includes a plurality of stroke data items corresponding to a plurality of strokes, respectively. In other words, time-series data means the assembly of time-series stroke data items corresponding to a plurality of strokes, respectively. Each stroke data item corresponds to a stroke and includes a series of coordinate data items (time-series coordinates) each corresponding to a point on the path of the stroke. The order in which the stroke data items are arranged is equivalent to the order in which the strokes are made.

The tablet computer 10 is configured to read an arbitrary existing time-series data item from the storage medium and display a handwritten document corresponding to the time-series data item on the screen. In other words, the tablet computer 10 is configured to display a plurality of strokes indicated by the time-series data item on the screen. The strokes indicated by the time-series data item are also strokes input in handwriting.

Further, the tablet computer 10 of the present embodiment has a touch input mode for performing a handwriting input operation with a finger without using the stylus 100. When the touch input mode is effective, the user can perform a handwriting input operation on the touch screen display 17, using a finger. During the handwriting input operation, the path of movement of the finger on the screen is drawn in real time. In short, strokes handwritten by the handwriting input operation (or the path of handwritten strokes) are drawn in real time. In this manner, a plurality of strokes input in handwriting are displayed on the screen.

The tablet computer 10 further has an edit function. The edit function allows the user to delete or move an arbitrary handwritten portion (an arbitrary handwritten character, mark, drawing, table, etc.) selected by a range selection tool in the handwritten document displayed in progress in accordance with a user's edit operation using an eraser tool, the range selection tool and other various tools. Moreover, an arbitrary handwritten portion selected by the range selection tool in a handwritten document can be specified as a search key for searching for the handwritten document. Further, a recognition process such as a handwritten character recognition, a handwritten drawing recognition or a handwritten table recognition can be applied to an arbitrary handwritten portion selected by the range selection tool in a handwritten document.

In the present embodiment, a handwritten document may be managed as one page or a plurality of pages. In this case, time-series data items (handwritten document data items) may be grouped for each area fit within one screen. A group of time-series data items fit within one screen may be recorded as one page. The size of a page may be changeable. In this case, the area of a page can be expanded so as to be greater than that of one screen. Therefore, a handwritten document larger than the screen can be dealt with as one page. When the whole part of one page cannot be simultaneously displayed on the display, the page may be scaled down, or the display target section on the page may be moved by scrolling the page vertically and laterally.

FIG. 2 shows an example of cooperative operations between the tablet computer 10 and external devices. The tablet computer 10 is configured to cooperate with a personal computer 1 and a cloud system. The tablet computer 10 comprises a wireless communication device such as a wireless LAN and is configured to wirelessly communicate with the personal computer 1. The tablet computer 10 is further configured to communicate with a server 2 on the Internet. The server 2 may be a server which executes an online storage service and other various cloud computing services.

The personal computer 1 comprises a storage device such as a hard disk drive (HDD). The tablet computer 10 is configured to transmit time-series data (handwritten document data) to the personal computer 1 via a network and store the data in the HDD of the personal computer 1 (this process may be referred to as upload). The personal computer 1 may authenticate the tablet computer 10 at the start of communication to obtain secure communication between the tablet computer 10 and the personal computer 1. In this case, a dialogue for prompting the user to input an ID or a password may be displayed on the screen of the tablet computer 10, or, for example, the ID of the tablet computer 10 may be automatically transmitted from the tablet computer 10 to the personal computer 1.

In this manner, even when the capacity of the storage of the tablet computer 10 is small, the tablet computer 10 is capable of dealing with a large number of time-series data items or a large volume of time-series data items.

The tablet computer 10 is configured to read (download) one or more arbitrary time-series data items stored in the HDD of the personal computer 1 and display the strokes indicated by the read time-series data items on the screen of the display 17 of the tablet computer 10. In this case, a list of thumbnails obtained by scaling down the pages of time-series data items, respectively, may be displayed on the screen of the display 17, or one page selected from the thumbnails may be displayed on the screen of the display 17 in the normal size.

As described above, the other party with which the tablet computer 10 communicates may not be the personal computer 1 and may be the server 2 on the cloud system which provides a storage service, etc. The tablet computer 10 is configured to transmit time-series data (handwritten document data) to the server 2 via a network and store the data in a storage device 2A of the server 2 (this process may be referred to as upload), The tablet computer 10 is further configured to read (download) arbitrary time-series data stored in the storage device 2A of the server 2 and display the path of each stroke indicated by the read time-series data on the screen of the display 17 of the tablet computer 10.

In this manner, in the present embodiment, the storage medium in which time-series data is stored may be any one of the storage device of the tablet computer 10, the storage device of the personal computer 1 and the storage device of the server 2.

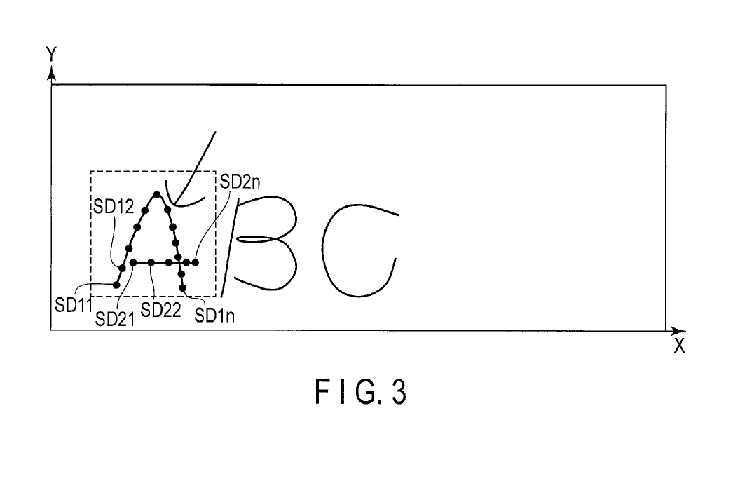

Now, this specification explains the relationship between strokes (characters, drawings, tables, etc.) made by the user and time-series data, referring to FIG. 3 and FIG. 4. FIG. 3 shows an example of a document (character string) handwritten on the touch screen display 17 using the stylus 100, etc.

In many cases, a character or drawing is handwritten in a document, and another character or drawing is handwritten on the character or drawing which has been already written. FIG. 3 assumes the following case: the character string “ABC” is handwritten in the order of “A”, “B” and “C”, and subsequently, an arrow is handwritten in vicinity to the handwritten character “A”.

The handwritten character “A” is shown by two strokes (a first stroke and a second stroke) made with the stylus 100; in short, by two paths. For example, the first handwritten stroke is shown by time-series coordinates (stroke data items) SD11, SD12, . . . SD1n sampled from the path of the stylus 100 in real time at equal time intervals. In a similar manner, the second stroke is shown by time-series coordinates (stroke data items) SD21, SD22, . . . SD2n. The number of coordinate data items showing one stroke may differ depending on the stroke data item.

The handwritten character “B” is shown by two strokes made with the stylus 100, etc.; in short, by two paths. The handwritten character “C” is shown by one stroke made with the stylus 100, etc.; in short, by one path. The handwritten arrow is shown by two strokes made with the stylus 100, etc.; in short, by two paths.

FIG. 4 shows time-series data 200 corresponding to the handwritten document shown in FIG. 3. The time-series data includes a plurality of stroke data items SD1, SD2, . . . SD7. In the time-series data 200, stroke data items SD1, SD2, . . . SD7 are arranged in the chronological order in which the strokes are made.

In the time-series data 200, the first two stroke data items SD1 and SD2 indicate the two strokes of the handwritten character “A”, respectively. The third and fourth stroke data items SD3 and SD4 indicate the two strokes constituting the handwritten character “B”, respectively. The fifth stroke data item SD5 indicates the stroke constituting the handwritten character “C”. The sixth and seventh stroke data items SD6 and SD7 indicate the two strokes constituting the handwritten arrow, respectively.

Each stroke data item includes a series of coordinate data items (time-series coordinates) corresponding to one stroke. In other words, each stroke data item includes a plurality of coordinates corresponding to a plurality of points on the path of one stroke, respectively. In each stroke data item, a plurality of coordinates are arranged in the chronological order in which the stroke is made.

For example, with regard to the handwritten character “A”, stroke data item SD1 includes a series of coordinate data items (time-series coordinates) each corresponding to a point on the path of the first stroke of the handwritten character “A”. In other words, stroke data item SD1 includes n coordinate data items SD11, SD12, . . . SD1n. Stroke data item SD2 includes a series of coordinate data items each corresponding to a point on the path of the second stroke of the handwritten character “A”. In other words, stroke data item SD2 includes n coordinate data items SD21, SD22, . . . SD2n. The number of coordinate data items may differ depending on the stroke data item.

Each coordinate data item indicates the X- and Y-coordinates corresponding to a point on the corresponding path. For example, coordinate data item SD11 indicates the X-coordinate (X11) and the Y-coordinate (Y11) of the starting point of the first stroke. SD1n indicates the X-coordinate (X1n) and the Y-coordinate (Y1n) of the end point of the first stroke.

Each coordinate data item may further include time stamp data T corresponding to the time when the point corresponding to the coordinates was handwritten. The time when the point was handwritten may be an absolute time (for example, year/month/day/hour/minute/second) or a relative time based on a time point. For example, the absolute time (for example, year/month/day/hour/minute/second) when the user started writing a stroke may be added as time stamp data to the corresponding stroke data item. The relative time indicating the difference from the absolute time may be added as time stamp data T to each coordinate data item of the stroke data item.

It is possible to further accurately show the temporal relationships between strokes by using time-series data in which time stamp data T is added to each coordinate data item.

Moreover, data Z indicating the writing pressure may be added to each coordinate data item.

The time-series data 200 having the structure explained in FIG. 4 is configured to show the temporal relationships between strokes as well as the path of each stroke. The use of the time-series data 200 allows the handwritten character “A” and the apical end portion of the handwritten arrow to be dealt with as a character or drawing different from each other even when the apical end portion of the arrow overlaps or is close to the character “A” as shown in FIG. 3.

In the present embodiment, as described above, handwritten document data is not stored as an image or a character recognition result. Instead, handwritten document data is stored as the time-series data 200 formed by the assembly of time-series stroke data items. Therefore, handwritten characters are allowed to be dealt with without relying on the language of the characters. Thus, the structure of the time-series data 200 of the present embodiment is allowed to be used in common with various countries using different languages in the world.

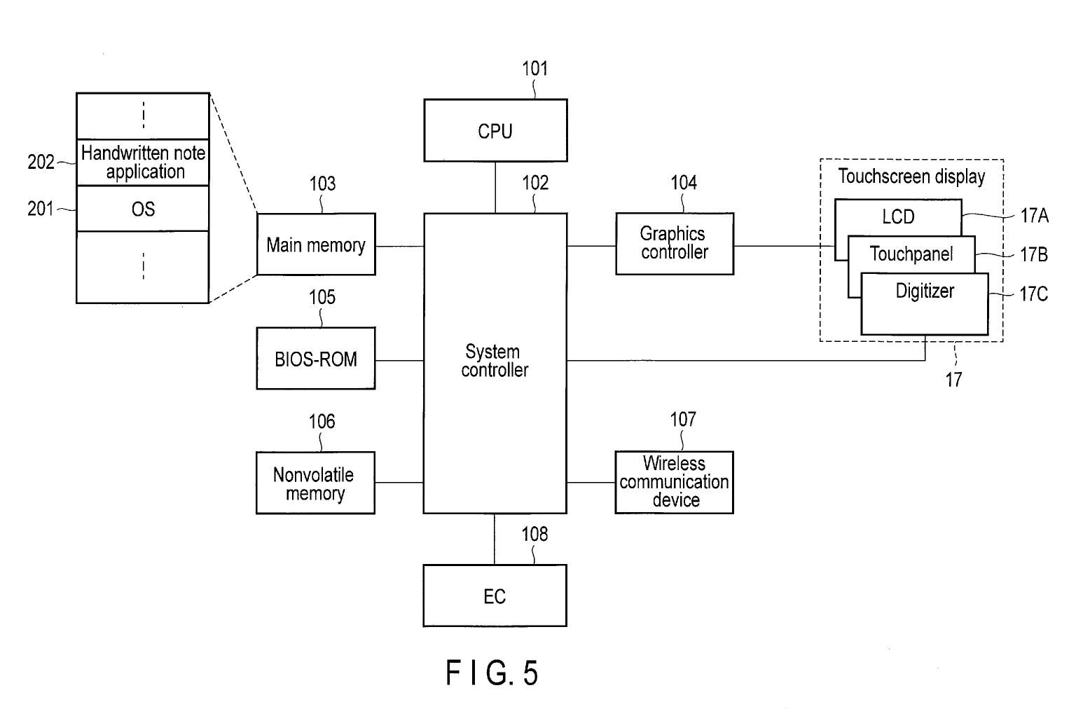

FIG. 5 shows a system configuration of the tablet computer 10.

The tablet computer 10 comprises, as shown in FIG. 5, a CPU 101, a system controller 102, a main memory 103, a graphics controller 104, a BIOS-ROM 105, a nonvolatile memory 106, a wireless communication device 107, an embedded controller (EC) 108, etc. The CPU 101 is a processor configured to control the operations of various modules of the tablet computer 10. The CPU 101 executes various types of software loaded from the nonvolatile memory 106 which is a storage device to the main memory 103. The software includes an operating system (OS) 201 and various application programs. The application programs include a handwritten note application program 202. The handwritten note application program 202 has a function of creating and displaying the above handwritten document data, a function of editing handwritten document data, a handwritten document search function for searching for a desired handwritten portion in handwritten document data, and a function of formatting a handwritten document based on handwritten document data.

The CPU 101 executes a Basic Input/Output System (BIOS) stored in the BIOS-ROM 105, The BIOS is a program for hardware control.

The system controller 102 is a device configured to connect a local bus of the CPU 101 and various components. The system controller 102 comprises a built-in memory controller configured to control the access to the main memory 103. The system controller 102 has a function of communicating with the graphics controller 104 through a serial bus conforming to the PCI EXPRESS standard, etc.

The graphics controller 104 is a display controller configured to control an LCD 17A used as a display monitor of the tablet computer 10. A display signal generated by the graphics controller 104 is sent to the LCD 17A. The LCD 17A displays a screen image based on the display signal. A touch panel 17B, the LCD 17A and a digitizer 17C overlap each other. The touch panel 17B is a capacitive pointing device for inputting data on the screen of the LCD 17A. The touch panel 17B detects the contact position of a finger on the screen, the movement of the contact position, etc. The digitizer 17C is an electromagnetic induction type of pointing device for inputting data on the screen of the LCD 17A. The digitizer 17C detects the contact position of the stylus (digitizer stylus) 100 on the screen, the movement of the contact position, etc.

The wireless communication device 107 is a device configured to perform wireless communication using, for example, a wireless LAN or 3G mobile communication. The EC 108 is a single-chip microcomputer including an embedded controller for power management. The EC 108 has a function of switching the tablet computer 10 on or off in response to the operation of a power button (not shown) by the user.

Now, this specification explains some typical examples of screens shown by the handwritten note application program 202 to the user.

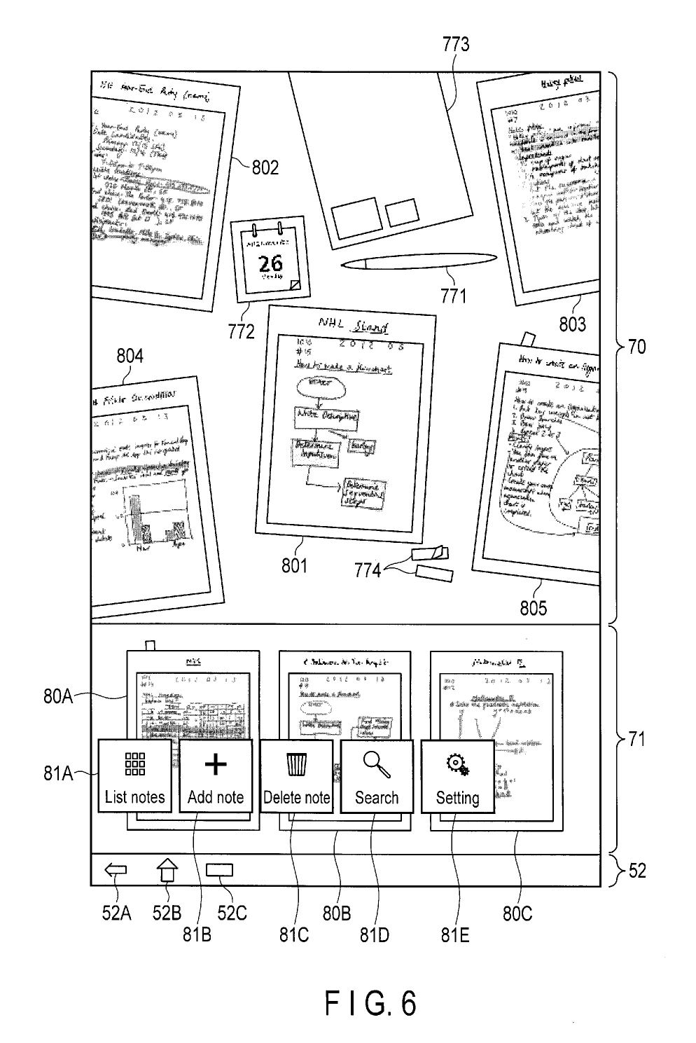

FIG. 6 shows a desktop screen displayed by the handwritten note application program 202. The desktop screen is a basic screen for dealing with a plurality of handwritten document data items. Hereinafter, handwritten document data is referred to as a handwritten note.

The desktop screen includes a desktop screen area 70 and a drawer screen area 71. The desktop screen area 70 is a temporary area configured to display a plurality of note icons 801 to 805 corresponding to a plurality of handwritten notes the user is working on. Each of the note icons 801 to 805 displays the thumbnail of a page of the corresponding handwritten note. The desktop screen area 70 further displays a pen icon 771, a calendar icon 772, a scrap note (gallery) icon 773 and a tag (label) icon 774.

The pen icon 771 is a graphical user interface (GUI) element for switching the display screen from the desktop screen to a page edit screen. The calendar icon 772 is an icon showing the current date. The scrap note icon 773 is a GUI element for viewing data loaded from other application programs or external files (hereinafter, referred to as scrap data or gallery data). The tag icon 774 is a GUI element for attaching a label (tag) to an arbitrary page in an arbitrary handwritten note.

The drawer screen area 71 is a display area for viewing a storage area for storing all of the created handwritten notes. The drawer screen area 71 displays note icons 80A, 80B and 80C corresponding to some of all handwritten notes. Each of the note icons 80A, 80B and 80C displays the thumbnail of a page of the corresponding handwritten note. The handwritten note application program 202 is configured to detect a gesture (for example, a swipe gesture) performed by the user with the stylus 100 or a finger on the drawer screen area 71. In response to the detection of the gesture (for example, a swipe gesture), the handwritten note application program 202 scrolls the screen image on the drawer screen area 71 to the left or right. In this way, it is possible to display note icons corresponding to arbitrary handwritten notes, respectively, in the drawer screen area 71.

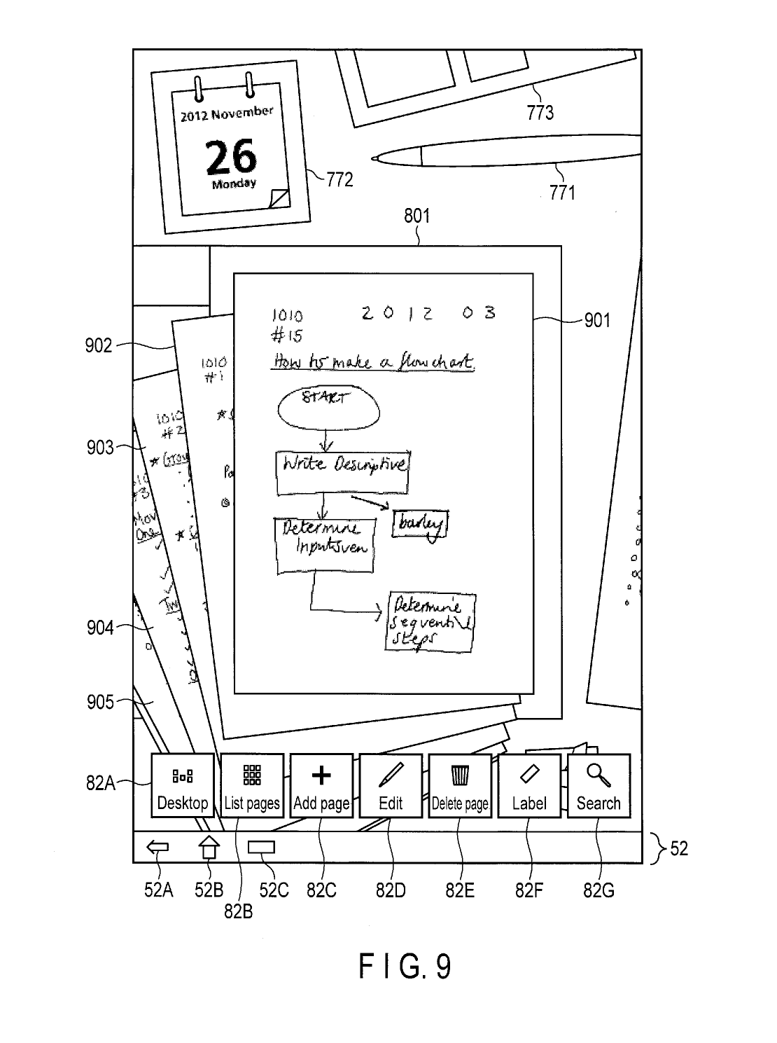

The handwritten note application program 202 is further configured to detect a gesture (for example, a tap gesture) performed by the user with the stylus 100 or a finger on the note icons in the drawer screen area 71. In response to the detection of a gesture (for example, a tap gesture) on a note icon in the drawer screen area 71, the handwritten note application program 202 moves the note icon to the middle portion of the desktop screen area 70. The handwritten note application program 202 selects a handwritten note corresponding to the note icon and displays the note preview screen shown in FIG. 9 instead of the desktop screen. The note preview screen shown in FIG. 9 is a screen which allows the user to view an arbitrary page in the selected handwritten note.

The handwritten note application program 202 is further configured to detect a gesture (for example, a tap gesture) performed by the user with the stylus 100 or a finger in the desktop screen area 70. In response to the detection of a gesture (for example, a tap gesture) on the note icon located in the middle portion of the desktop screen area 70, the handwritten note application program 202 selects a handwritten note corresponding to the note icon located in the middle portion and displays the note preview screen shown in FIG. 9 instead of the desktop screen.

The desktop screen is further configured to display a menu. This menu comprises a list note button 81A, a note addition button 81B, a note deletion button 81C, a search button 81D and a setting button 81E. The list note button 81A is a button for displaying a list of handwritten notes. The note addition button 81B is a button for opening (adding) a new handwritten note. The note deletion button 81C is a button for deleting a handwritten note. The search button 81D is a button for opening a search screen (search dialogue). The setting button 81E is a button for opening a setting screen.

A return button 52A, a home button 52B and a recent application button 52C are displayed in a bar 52. When the display position of the software button group is set to the left in advance by an operation of the user, the return button 52A, the home button 52B and the recent application 52C are displayed on the left side of the default display position; in other words, in the left part of the bar 52, as shown in FIG. 6.

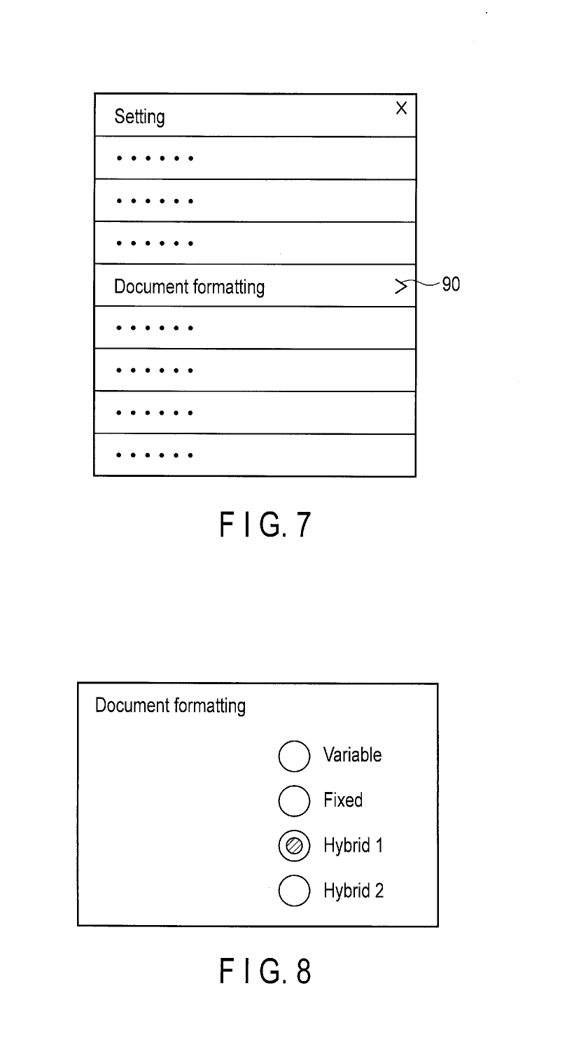

FIG. 7 shows a setting screen which is opened when the setting button 81E is tapped with the stylus 100 or a finger.

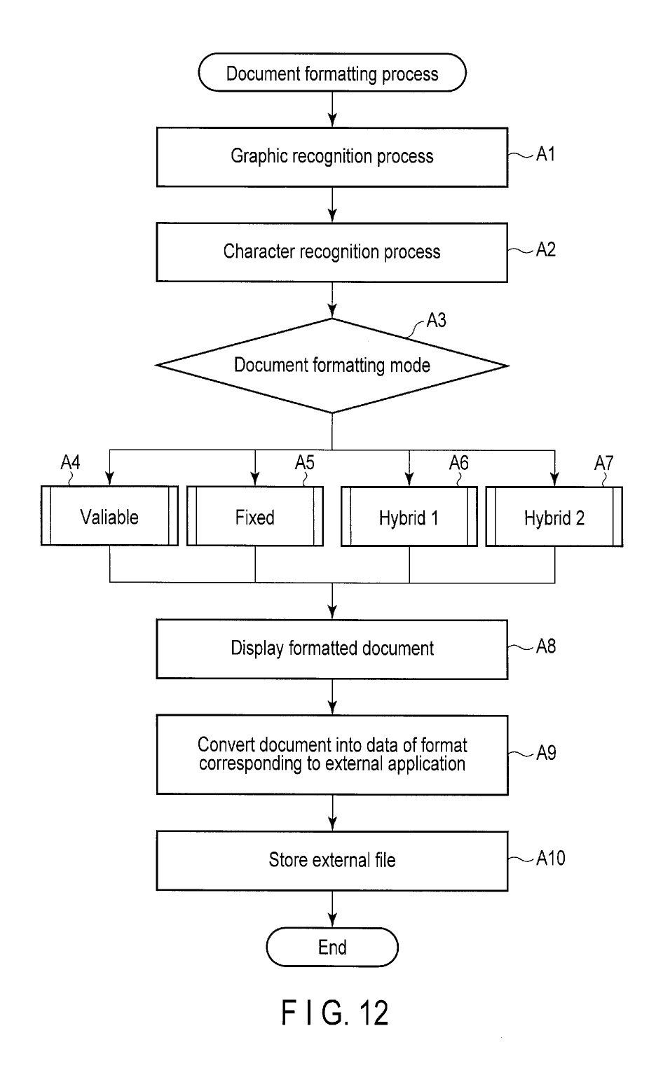

This setting screen displays various setting items. The setting items include document formatting. When a button 90 corresponding to the setting item “document formatting” is tapped with the stylus 100 or a finger, a document formatting mode setting screen for setting a document formatting mode in a document formatting process is displayed as shown in FIG. 8. The document formatting mode shows a method of formatting documents and is referred to when a document formatting process is executed. As shown in FIG. 8, the document formatting mode includes, for example, “Variable”, “Fixed”, “Hybrid 1” and “Hybrid 2”. The detail of each document formatting mode is explained later (FIG. 12 to FIG. 16).

FIG. 9 shows the note preview screen described above.

The note preview screen is a screen which allows the user to view an arbitrary page in the selected handwritten note. Here, it is assumed that a handwritten note corresponding to note icon 801 is selected. In this case, the handwritten note application program 202 displays a plurality of pages 901, 902, 903, 904 and 905 included in the handwritten note such that at least a part of each of the pages 901, 902, 903, 904 and 905 is viewable, and the pages 901, 902, 903, 904 and 905 overlap each other.

The note preview screen further displays the pen icon 771, the calendar icon 772, the scrap note icon 773 and the tag icon 774.

The note preview screen is further configured to display a menu. This menu comprises a desktop button 82A, a list page button 82B, a page addition button 82C, an edit button 82D, a page deletion button 82E, a label button 82F and a search button 82G. The desktop button 82A is a button for displaying the desktop screen. The list page button 82B is a button for displaying a list of pages in the handwritten note which is currently selected. The page addition button 82C is a button for opening (adding) a new page. The edit button 82D is a button for displaying the page edit screen. The page deletion button 82E is a button for deleting a page. The label button 82F is a button for displaying a list of types of usable labels. The search button 82G is a button for displaying the search screen.

The return button 52A, the home button 52B and the recent application button 52C are displayed in the bar 52. When the display position of the software button group is set to the left in advance by an operation of the user, the return button 52A, the home button 52B and the recent application 52C are displayed on the left side of the default display position; in other words, in the left part of the bar 52, as shown in FIG. 9.

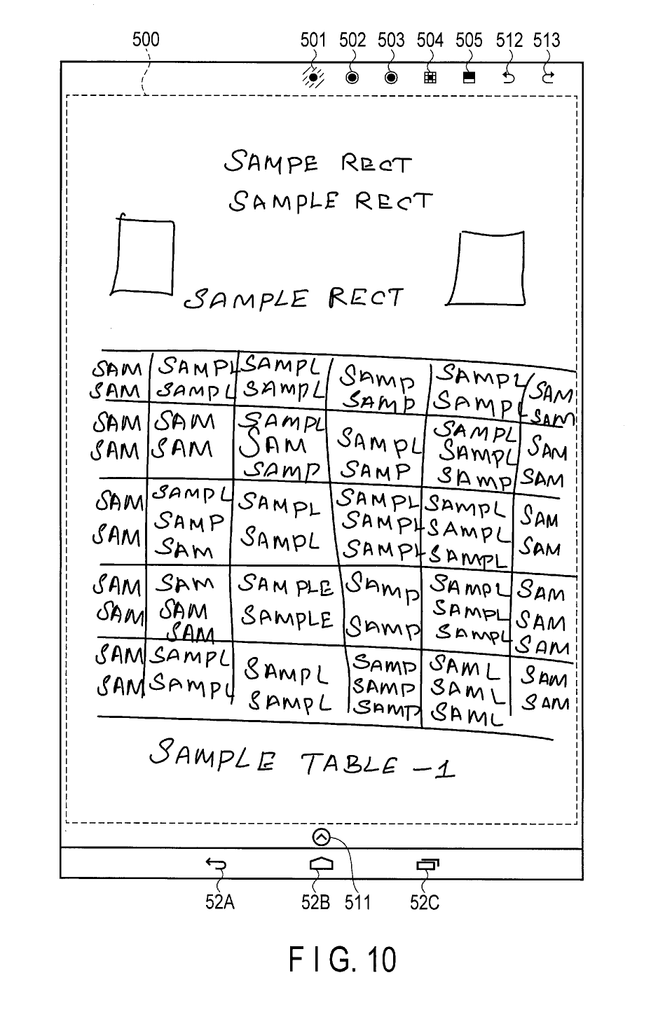

The handwritten note application program 202 is configured to detect various gestures performed by the user on the note preview screen. For example, in response to the detection of a gesture, the handwritten note application program 202 changes the page to be displayed on the top to an arbitrary page (page advance or page return). In response to the detection of a gesture (for example, a tap gesture) performed on the top page, the detection of a gesture (for example, a tap gesture) performed on the pen icon 771, or the detection of a gesture (for example, a tap gesture) performed on the edit button 82D, the handwritten note application program 202 selects the top page and displays the page edit screen shown in FIG. 10 instead of the note preview screen.

The page edit screen shown in FIG. 10 is a screen which allows the user to open a new page (handwritten page) and view and edit an existing page. When the page 901 on the note preview screen shown in FIG. 9 is selected, the content of page 901 is displayed on the page edit screen.

On the page edit screen, a rectangular area 500 surrounded by broken lines is a handwriting input area which allows the user to input data in handwriting. In the handwriting input area 500, an input event from the digitizer 17C is used to display (draw) handwritten strokes and is not used as an event indicating a gesture such as a tap gesture. On the other hand, in the areas other than the handwriting input area 500 on the page edit screen, an input event from the digitizer 17C may be also used as an event indicating a gesture such as a tap gesture.

An input event from the touch panel 17B is not used to display (draw) handwritten strokes and is used as an event indicating a gesture such as a tap gesture or a swipe gesture.

The page edit screen further displays a quick select menu including three types of pens 501 to 503 registered by the user in advance, a range selection pen 504 and an eraser pen 505. The page edit screen further displays a page return button 512 and a page advance button 513.

Here, it is assumed that the black pen 501, the red pen 502 and the marker 503 are registered by the user in advance. The user taps a pen (button) from the quick select menu with the stylus 100 or a finger in order to switch the pen type to be used. For example, the handwritten note application program 202 displays black strokes (paths) on the page edit screen in accordance with the movement of the stylus 100 when a handwriting input operation is performed with the stylus 100 on the page edit screen in a state where the black pen 501 is selected by the user with a tap gesture using the stylus 100 or a finger.

The pen type may be also switched between the above three types of pens in the quick select menu by an operation of a side button of the stylus 100. A combination of a pen color and thickness which are frequently used may be set for each of the three types of pens in the quick select menu.

The handwritten note application program 202 sets a range on the page edit screen in accordance with the movement of the stylus 100 when a handwriting input operation is performed on the page edit screen with the stylus 100 in a state where the range selection pen 504 is selected by the user with a tap gesture using the stylus 100 or a finger. For example, the range is set by specifying two points on the opposing corners of a rectangle with a handwriting input operation.

When the range is selected with the range selection pen 504, the handwritten note application program 202 displays a menu for instructing the page on which the range is selected to be processed. This menu includes, for example, a deletion button, a copy button, a cut button, an export button, an e-mail button and a browser button.

The deletion button is a button for deleting data of the selected range. The copy button is a button for copying data of the selected range. The copied data can be pasted to another position on the page. The cut button is a button for cutting (deleting) data of the selected range. The export button is a button for displaying an export menu. The export menu includes, for example, a presentation button, a document button, an image button and a share button.

The presentation button is a button for converting the handwritten document data of the selected range into a file for a presentation program and outputting the file. The document button is a button for converting the handwritten document data of the selected range into text data by a character recognition process and outputting the text data as a document file. The image button is a button for converting the handwritten document data of the selected range into an image file and outputting the image file. The share button is a button for converting the handwritten document data of the selected range into an image file and sharing the image file with other applications.

The e-mail button is a button for converting the characters of the selected range into text data by a character recognition process, initiating an e-mail program and displaying the text data as the data of the e-mail text. The browser button is a button for converting the characters of the selected range into text data by a character recognition process, initiating a Web-browser program and executing a Web search based on the recognized text data.

The handwritten note application program 202 deletes a stroke displayed on the page edit screen in accordance with the movement of the stylus 100 when a handwriting input operation is performed on the page edit screen with the stylus 100 in a state where the eraser pen 505 is selected by the user with a tap gesture using the stylus 100 or a finger.

The page edit screen further displays a menu button 511.

The menu button 511 is a button for displaying a menu. This menu may comprise, for example, a button for returning to the note preview screen, a button for adding a new page and a search button for opening the search screen. The menu may further comprise a sub-menu for export or import. As the sub-menu for export, a menu for allowing the user to select a function of recognizing the handwritten page displayed on the page edit screen and converting the page into an electronic document file, a presentation file, etc., may be used.

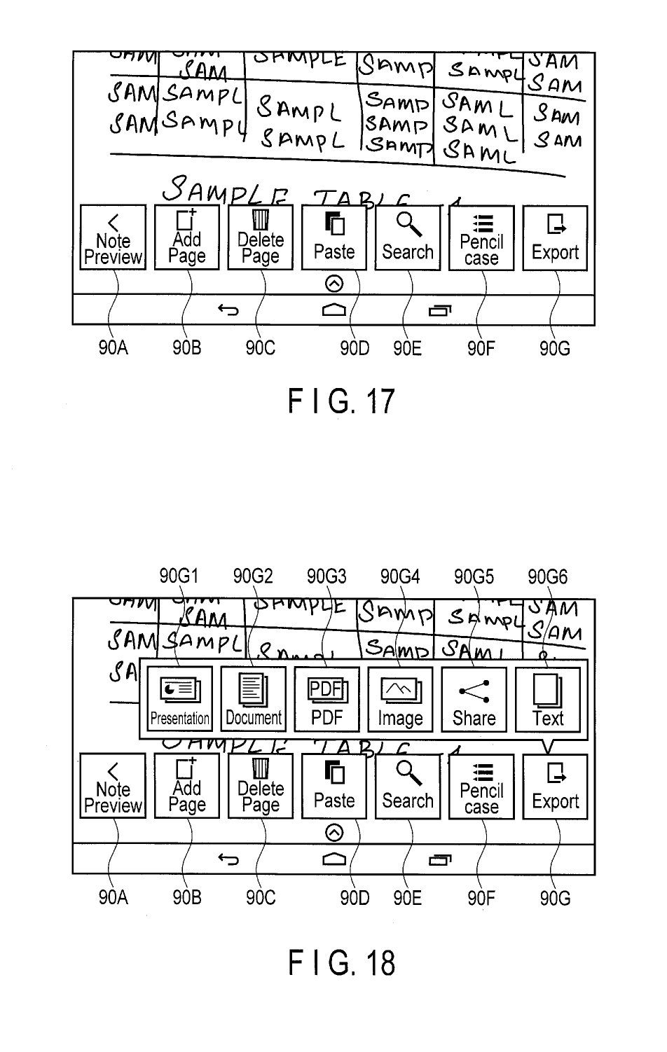

The menu may further comprise a button for activating a process of converting a handwritten page into text and transmitting the text by e-mail. Moreover, the menu may comprise a button for invoking a pen setting screen which allows the user to change the color (the line color to be drawn) and the thickness (the line thickness to be drawn) of each of the three types of pens in the quick select menu (see FIG. 17 and FIG. 18 for details).

The return button 52A, the home button 52B and the recent application button 52C are displayed in the bar 52.

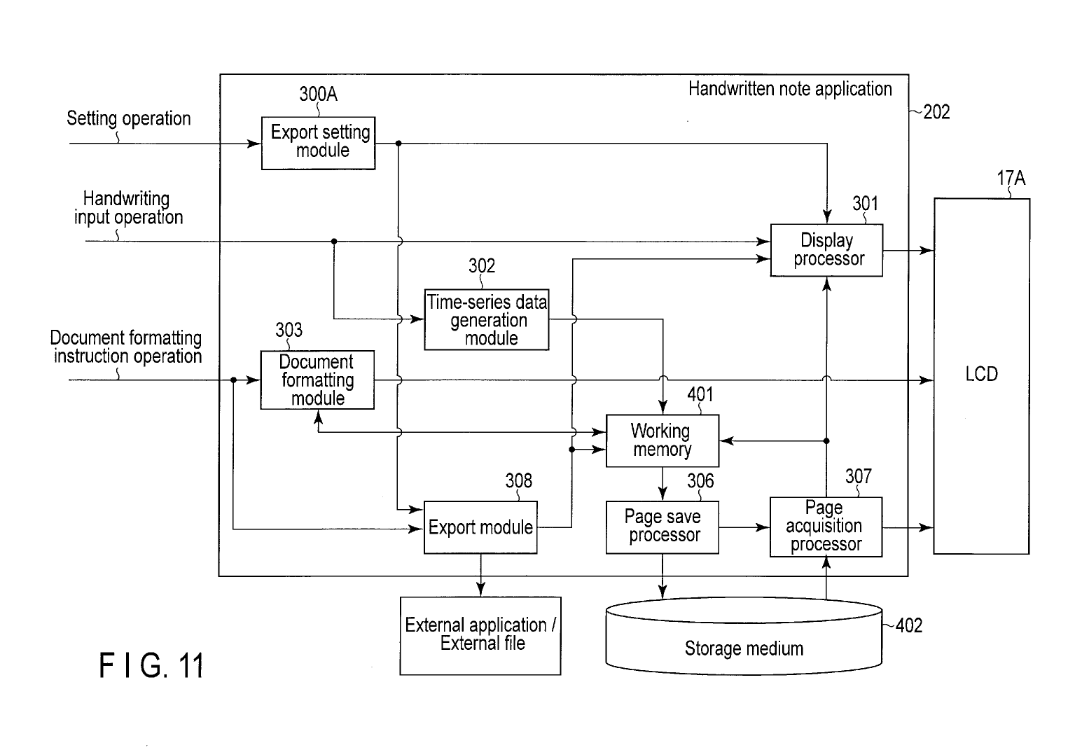

Now, a configuration structure of the handwritten note application program 202 will be explained with reference to FIG. 11.

The handwritten note application program 202 is a WYSIWYG application configured to deal with handwritten document data. The handwritten note application program 202 comprises, for example, an export setting module 300A, a display processor 301, a time-series data generation module 302, a document formatting module 303, a page save processor 306, a page acquisition processor 307 and an export module 308.

The touch panel 17B is configured to detect the generation of an event such as an event “touch (contact)”, “move (slide)” or “release”. The event “touch (contact)” is an event indicating that an object (finger) makes into contact with the screen. The event “move (slide)” is an event indicating that the contact position is moved while an object (finger) makes into contact with the screen. The event “release” is an event indicating that an object (finger) is separated from the screen.

The digitizer 17C is also configured to detect the generation of an event such as an event “touch (contact)”, “move (slide)” or “release”. The event “touch (contact)” is an event indicating that an object (the stylus 100) makes into contact with the screen. The event “move (slide)” is an event indicating that the contact position is moved while an object (the stylus 100) makes into contact with the screen. The event “release” is an event indicating that an object (the stylus 100) is separated from the screen.

The handwritten note application program 202 displays a page edit screen for opening, viewing and editing handwritten document data on the touch screen display 17. The export setting module 300A displays the menu screen for setting the document formatting mode as shown in FIG. 8 and sets the document formatting mode in accordance with the operation of the user interface by the user.

The display processor 301 and the time-series data generation module 302 receive an event “touch (contact)”, “move (slide)” or “release” generated by the digitizer 17C and detect a handwriting input operation by the reception. The event “touch (contact)” includes the coordinates of the contact position. The event “move (slide)” includes the coordinates of the contact position and the coordinates of the contact position of the destination of the move. Thus, the display processor 301 and the time-series data generation module 302 are configured to receive a series of coordinates corresponding to the path of the movement of the contact position from the digitizer 17C.

The display processor 301 displays handwritten strokes on the screen in accordance with the movement of an object (the stylus 100) on the screen detected by the digitizer 17C on the screen. The display processor 301 displays the path of the stylus 100 in a contact period of the stylus 100, in short, the path of each stroke, on the page edit screen. The display processor 301 is further configured to display various types of content data (image data, audio data, text data and data created by drawing applications) imported from external applications or external files on the page edit screen.

The time-series data generation module 302 receives the above series of coordinates output from the digitizer 17C and generates handwritten data including time-series data (a series of coordinate data items) having the structure explained in FIG. 4 in detail based on the series of coordinates. The time-series data generation module 302 temporarily stores the generated handwritten data in a working memory 401.

The document formatting module 303 formats the handwritten document which is displayed on a handwritten page and displays the formatted data. The document formatting module 303 includes, for example, a stroke division module, a graphic recognition module, a character recognition module and a formatting module.

The stroke division module divides the stroke data of a plurality of strokes included in handwritten document data into a first stroke group and a second stroke group. The first stroke group indicates handwritten tables or drawings. The second stroke group indicates characters and has features different from those of strokes indicating tables or drawings. For example, the stroke division module has data showing the features of strokes by language (English, Japanese, etc.) regarding character strings, the features of strokes of various graphic patterns such as a circle, a square, an arrow and a straight line regarding drawings, and the features of combinations of linear strokes constituting a table regarding tables. Based on this data, the stroke division module classifies the stroke data into the first stroke group or the second stroke group.

For example, in many cases, the stroke density of a stroke group showing a character string is higher than that of a handwritten drawing or table, and further, stroke groups showing a character string are arranged laterally or longitudinally within a constant width. The stroke density of a stroke group showing a drawing is lower than that of a character string. A stroke group showing a drawing has the features of strokes of one of graphic patterns. With regard to strokes showing a table, linear strokes are arranged longitudinally or laterally, and further, the end of each stroke is close to another stroke. The stroke division module classifies the stroke data into the first stroke group and the second stroke group based on the features of the strokes.

The graphic recognition module executes a graphic recognition process for converting the stroke data classified into the first stroke group by the stroke division module into one of predetermined graphic objects (a circle, a square, an arrow, etc.). The graphic recognition module has graphic data showing the features of graphic objects and calculates the similarity between strokes of a handwritten drawing and each graphic object. The graphic recognition module determines that the graphic object having the highest similarity is the recognition result of the stroke group. The similarity can be calculated by dealing with each of the path data of strokes of a handwritten drawing and the path data of each graphic object as the assembly of vectors and comparing the assemblies of vectors with each other.

In the calculation of similarity, a handwritten drawing (stroke group) may be rotated, enlarged or reduced depending on the need. The similarity is calculated between the rotated, enlarged or reduced handwritten drawing and each graphic object. A graphic recognition module 315B selects the graphic object having the highest similarity to the handwritten drawing as the recognition result and adds attribute information indicating the process of rotation, enlargement or reduction applied to the handwritten drawing. It is possible to convert strokes showing a handwritten drawing into a formatted drawing and display the formatted drawing by rotating, enlarging or reducing a graphic object in accordance with attribute information.

With respect to the stroke data classified into the first stroke group by the stroke division module, the graphic recognition module determines the number of columns and rows or the size of each cell based on the combination of longitudinal and lateral linear strokes. The number of columns and rows or the size of each cell defines the shape of the table.

The character recognition module applies a character recognition process to the stroke data classified into the second stroke group by the stroke division module and generates a character code of each handwritten character shown by the stroke group.

The formatting module includes a graphic formatting module configured to format drawings or tables based on the recognition result obtained by the graphic recognition module, and a character formatting module configured to format characters by displaying a predetermined character font instead of a handwritten character based on the recognition result obtained by the character recognition module.

The graphic formatting module converts strokes recognized as a drawing or a table by the graphic recognition module into a pattern (a first shape pattern) showing a drawing or a table. The graphic formatting module determines the drawing size or the table size (the height of columns and rows, etc.) of the first shape pattern so as to display the first shape pattern in the positions of strokes showing the handwritten drawing or table on the page. For example, the graphic formatting module sets a circumscribed rectangle around the stroke group showing the handwritten drawing or table and determines the display position of a formatted drawing or table based on the position of a vertex of the circumscribed rectangle (for example, the coordinates of the upper left vertex). When a plurality of strokes are recognized as forming a table, the graphic formatting module may supplement the table with lacking strokes and format the table. For example, when a stroke forming the outer frame of a table is not present, a line equivalent to the outer frame of the table may be added. When most strokes indicating lateral lines are close to or intersect with a vertical line, but one or a few strokes indicating lateral lines are not close to the vertical line, these strokes may be converted into lines which reach the vertical line.

The character formatting module converts strokes showing a character recognized by the character recognition module into a character font (a second shape pattern) based on the recognition result (character code). The character formatting module determines the character size (character font) and the display position of the second shape pattern so as to display the second shape pattern in the positions (for example, the upper left vertex of the circumscribed rectangle) of strokes indicating the handwritten character on the page. The character formatting module is configured to separately apply a different formatting process to a handwritten character (the second stroke group) included in the range defined by strokes (the first stroke group) showing a drawing or table, and a handwritten character which is not included in the range in accordance with the document formatting mode. The range defined by strokes showing a drawing or table is, for example, a range included in the circumscribed rectangle set around the stroke group showing the drawing or table. When the circumscribed rectangle set around a stroke group equivalent to a character (or a character string) is included in the circumscribed rectangle of a drawing or table with a predetermined proportion (for example, 70%) or higher, the stroke group may be determined that it is included in the drawing or table.

The page save processor 306 saves handwritten document data including a plurality of stroke data items corresponding to a plurality of handwritten strokes included in a handwritten page in a storage medium 402. The storage medium 402 may be, for example, the storage device of the tablet computer 10 or the storage device of the server computer 2.

The page acquisition processor 307 obtains arbitrary handwritten document data from the storage medium 402. The obtained handwritten document data is supplied to the display processor 301. The display processor 301 displays a plurality of strokes corresponding to a plurality of stroke data items included in handwritten document data on the screen.

The export module 308 converts the process result obtained by the document formatting module 303 into data in the data format of the specified destination of the conversion and generates a file for an external application. The export module 308 is configured to generate a file having a data format corresponding to, for example, a presentation application, a document preparation application, an image display application and a text process application and output the file.

Now, this specification explains the document formatting process of the embodiment.

When the setting button 81E is selected on the desktop screen shown in FIG. 6, and the button 90 corresponding to document formatting in FIG. 7 is selected, the export setting module 300A displays the document formatting mode setting screen shown in FIG. 8. On the document formatting mode setting screen shown in FIG. 8, for example, one of the formatting modes “Variable”, “Fixed”, “Hybrid 1” and “Hybrid 2” can be selected.

The formatting mode “Variable” is a mode configured to output a formatted pattern in association with the positions of strokes showing a drawing or table in a handwritten document (page) with respect to drawings or tables, and automatically adjust the font size of characters in a handwritten document (page) and output the characters regardless of whether or not the characters are included in a drawing or table with respect to characters. In the formatting mode “Variable”, strokes of a character included in a drawing or table are automatically adjusted so as to have a font size fit within the drawing or table while the layout of the drawing or table is maintained. Strokes of a character which is not included in a drawing or table are automatically adjusted so as to have a font size corresponding to the size (for example, the height of the circumscribed rectangle) of handwritten strokes. The font size is adjusted for each drawing or each cell of a table. It is possible to output a drawing or table with a layout similar to that of the original handwritten document by performing document formatting in the formatting mode “Variable”.

The formatting mode “Fixed” is configured to adjust the font size of characters in a handwritten document (page) to a fixed font size determined in advance regardless of whether or not the characters are included in a drawing or table with respect to characters, and automatically adjust the size of a drawing or table such that the characters having the formatted font size included in the drawing or table are fit within the drawing or table with respect to drawings or tables. The size of characters outside a drawing or table is made uniform by performing document formatting in the formatting mode “Fixed”. In this manner, the document can be formatted so as to be pleasing to the eye.

The formatting mode “Hybrid 1” is configured to output a formatted pattern in association with the positions of strokes showing a drawing or table in a handwritten document (page) with respect to drawings or tables. With respect to characters, the formatting mode “Hybrid 1” is configured to automatically adjust strokes of characters included in a drawing or table so as to have a font size included in the drawing or table while the layout of the drawing or table is maintained, and adjust strokes of characters which are not included in a drawing or table such that the font size of the characters is a fixed font size determined in advance. A drawing or table can be output with a layout similar to that of the original handwritten document by performing document formatting in the formatting mode “Hybrid 1”. Moreover, the document can be formatted so as to be pleasing to the eye by making uniform the size of characters outside a drawing or table. Thus, it is possible to format characters as well as drawings and tables so as not to create incongruity in comparison with the original handwritten document.

The formatting mode “Hybrid 2” is configured to perform a process similar to that of the formatting mode “Hybrid 1” with respect to drawings or tables. The formatting mode “Hybrid 2” is configured to automatically adjust characters included in a drawing or table so as to have a font size fit within the drawing or table, and further adjust the font size of the other character included in the drawing or table to the font size of any one of the formatted characters. For example, the font size of all of the characters in a drawing or table is made uniform in accordance with the smallest font size in the drawing or table. A drawing or table can be output with a layout similar to that of the original handwritten document by performing document formatting in the formatting mode “Hybrid 2”. Moreover, the document can be formatted so as to be pleasing to the eye by separately making uniform the size of characters outside the drawing or table and the size of characters inside the drawing or table.

The document formatting mode setting screen shown in FIG. 8 allows the user to select one of the formatting modes created in advance; however, a formatting mode using another method may be set. For example, the document formatting mode setting screen may allow the user to set whether characters should be automatically adjusted or be adjusted to a fixed size separately for characters inside a drawing or table and characters outside a drawing or table. In this manner, for example, the user can set a formatting mode configured to fix the size of characters inside a drawing or table and automatically adjust the size of characters outside a drawing or table.

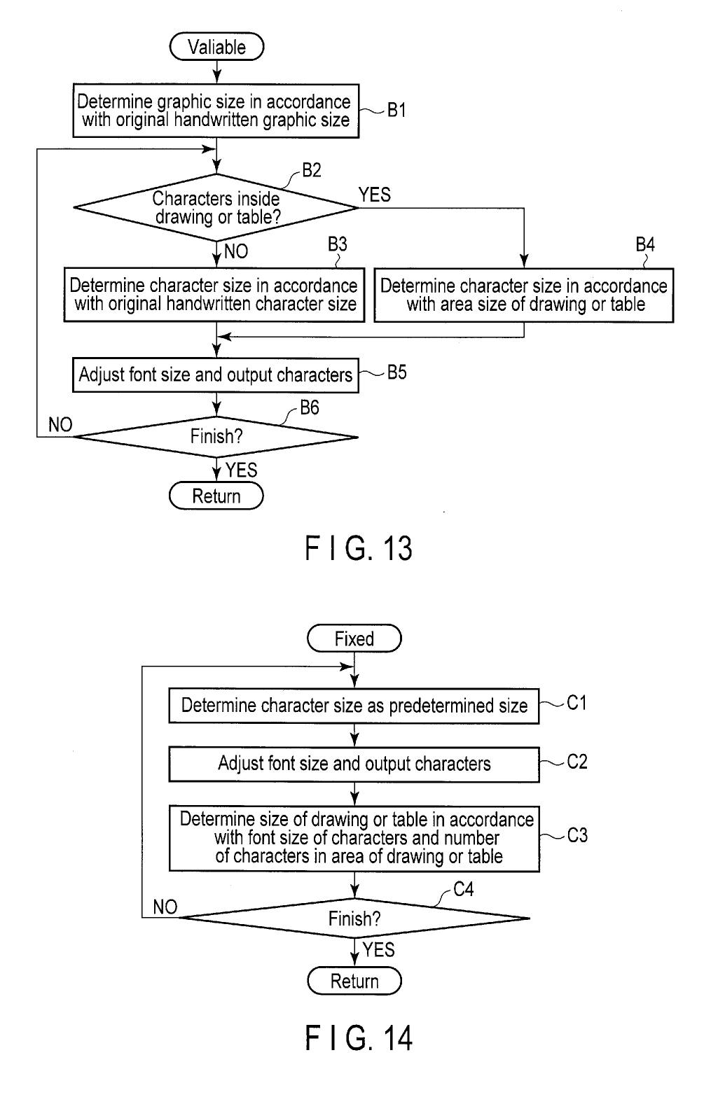

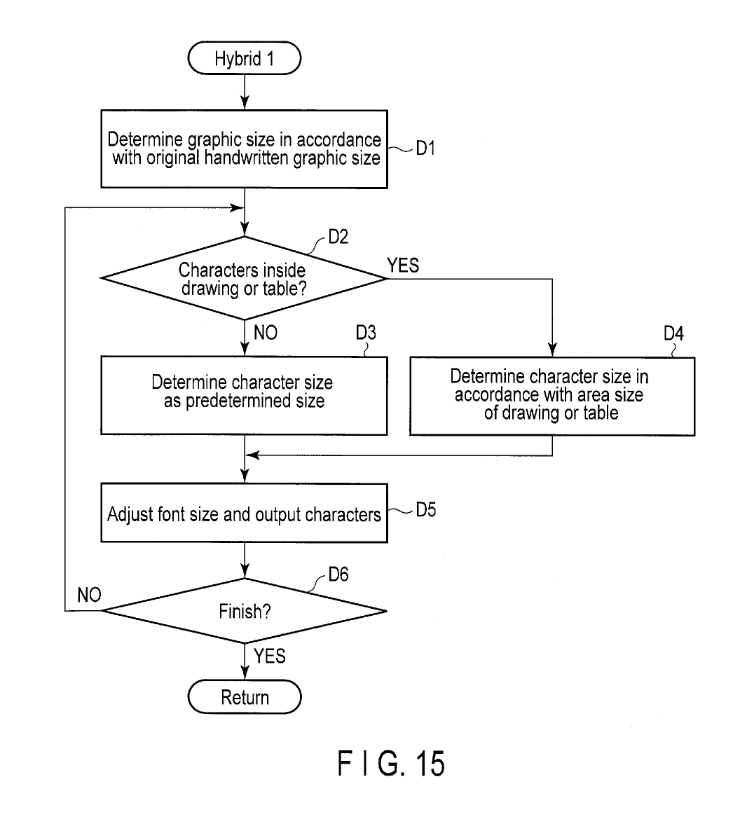

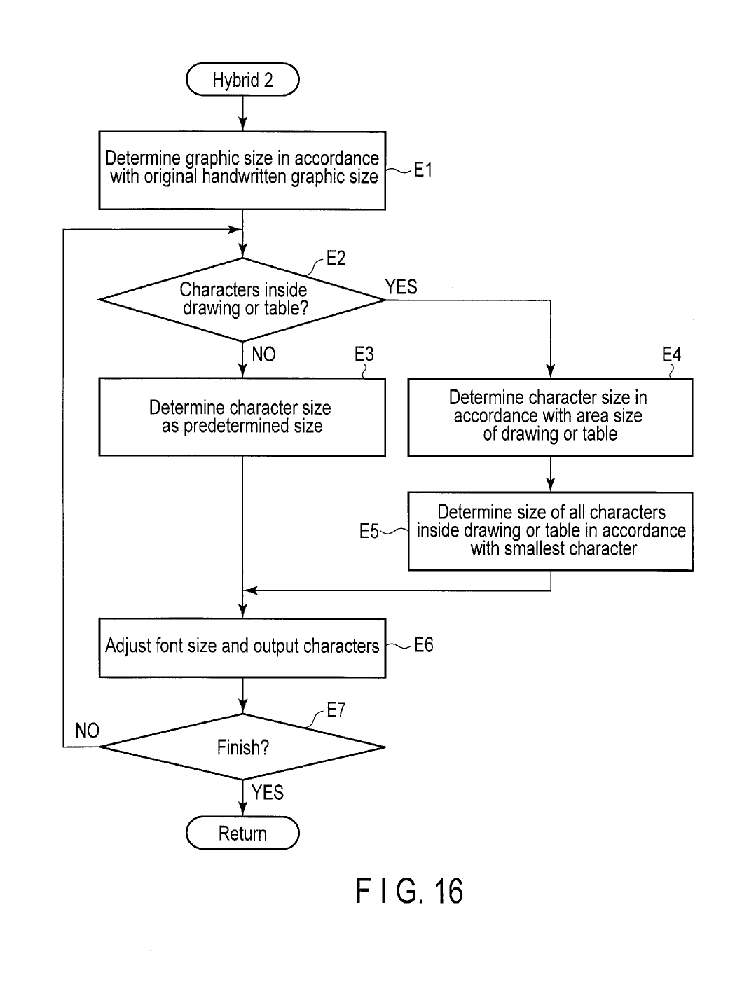

Hereinafter, the document formatting process of the embodiment is explained with reference to the flowcharts shown in FIG. 12, FIG. 13, FIG. 14, FIG. 15 and FIG. 16. FIG. 12 is a flowchart showing steps of the document formatting process as a whole. FIG. 13 is a flowchart showing steps of a process performed when the formatting mode “Variable” is set. FIG. 14 is a flowchart showing steps of a process performed when “Fixed” is set. FIG. 15 is a flowchart showing steps of a process performed when “Hybrid 1” is set. FIG. 16 is a flowchart showing steps of a process performed when “Hybrid 2” is set.

Here, for example, it is assumed that a handwritten document (handwritten page) is created with the stylus 100 as shown by the page edit screen of FIG. 10. When the handwritten document is formatted, the user selects the menu button 511. The handwritten note application program 202 displays a plurality of menus as shown in, for example, FIG. 17 in response to the selection of the menu button 511. The menus shown in FIG. 17 comprise a note preview button 90A, a note addition button 90B, a page deletion button 90C, a paste button 90D, a search button 90E, a pen setting button 90F and an export button 90G. When the menu portion is flicked, buttons (for example, an import button and an e-mail button) which are not displayed can be further displayed.

When the user selects the export button 90G, the handwritten note application program 202 displays sub-menus related to export as shown in, for example, FIG. 18. The sub-menus include, as shown in FIG. 18, a presentation button 90G1, a document button 90G2, a PDF button 90G3, an image button 90G4, a share button 90G5 and a text button 90G6. The presentation button 90G1 is a button for converting a handwritten document into a file having a data format for a presentation application and outputting the file. The document button 90G2 is a button for converting a handwritten document into a file having a data format for a document preparation application and outputting the file. The PDF button 90G3 is a button for converting a handwritten document into a file having a data format of a Portable Document Format (PDF) for an image display application and outputting the file. The image button 90G4 is a button for converting a handwritten document into a file having an image data format for an image display application and outputting the file. The share button 90G5 is a button for outputting a handwritten document to an image file having an image data format and sharing the file with other applications. The text button 90G6 is a button for outputting a text data file created by character recognition from a handwritten document.

When the user selects the presentation button 90G1 or the document button 90G2, the document formatting module 303 detects this selection as an operation for instructing document formatting and starts a document formatting process. Now, the outline of the document formatting process is explained with reference to the flowchart shown in FIG. 12.

The stroke division module of the document formatting module 303 inputs handwritten document data (stroke data) through the working memory 401 and divides strokes into the first stroke group and the second stroke group. The first stroke group indicates a handwritten table or drawing. The second stroke group indicates a character and has features different from those of strokes indicating a table or drawing.

The graphic recognition module of the document formatting module 303 executes a graphic recognition process for converting stroke data classified into the first stroke group by the stroke division module into one of predetermined graphic objects (for example, a circle, a square and an arrow) (step A1). The character recognition module of the document formatting module 303 applies a character recognition process to stroke data classified into the second stroke group by the stroke division module and generates a character code of each handwritten character shown by the stroke group (step A2).

The document formatting module 303 determines the document formatting mode set in advance (step A3) and executes a formatting process in accordance with the set document formatting mode (step A4, A5, A6 or A7). The specific examples of document formatting in accordance with each document formatting mode are explained in detail later.

In the above explanation, the document formatting mode is set in advance through the document formatting mode setting screen displayed by the operation of the setting button 81E. However, the document formatting mode may be set every time the presentation button 90G1 or the document button 90G2 is selected. For example, when the presentation button 90G1 or the document button 90G2 is selected, the handwritten note application program 202 displays the document formatting mode setting screen and allows the user to set one of the document formatting modes. In this manner, the user is able to easily set an appropriate document formatting mode in accordance with the content of the target handwritten document for document formatting.

The document formatting module 303 displays a document obtained by executing the formatting process (step A8). The export module 308 converts the document obtained by the document formatting module 303 into a data format corresponding to an external application (step A9), outputs the document as an external file and stores the file (step A10).

Now, the specific examples of document formatting in each document formatting mode are explained.

When the document formatting mode is “Variable”, the formatting module of the document formatting module 303 performs a process as shown in the flowchart of FIG. 13. The graphic formatting module converts strokes recognized as a drawing or table by the graphic recognition module into a pattern (the first shape pattern) showing a drawing or table. At this time, the graphic formatting module determines the graphic size in accordance with the original handwritten graphic size (step B1). In other words, the position and the size (layout) of a drawing or table are determined so as not to largely shift the correspondence between the drawing or table in a handwritten document and the drawing or table in a formatted document.

When character strokes are located inside a drawing or table (Yes in step B2), the character formatting module determines the size of the formatted character in accordance with the area size of the drawing or table (step B4) and determines the font size corresponding to the character size (step B5). The font size is automatically adjusted so as to be fit within the drawing or table while the layout of the drawing or table is maintained.

On the other hand, when character strokes are not located inside a drawing or table (No in step B2), the character formatting module determines the size of the formatted character in accordance with the size of the original handwritten character (step B3) and determines the font size corresponding to the character size (step B5). Thus, character strokes are converted into characters having a predetermined character size which is set in accordance with the character size in a handwritten document is the size of the converted character. The character formatting module repeatedly applies the above process to all of the character stroke blocks in a handwritten document until the end (steps B2 to B6).

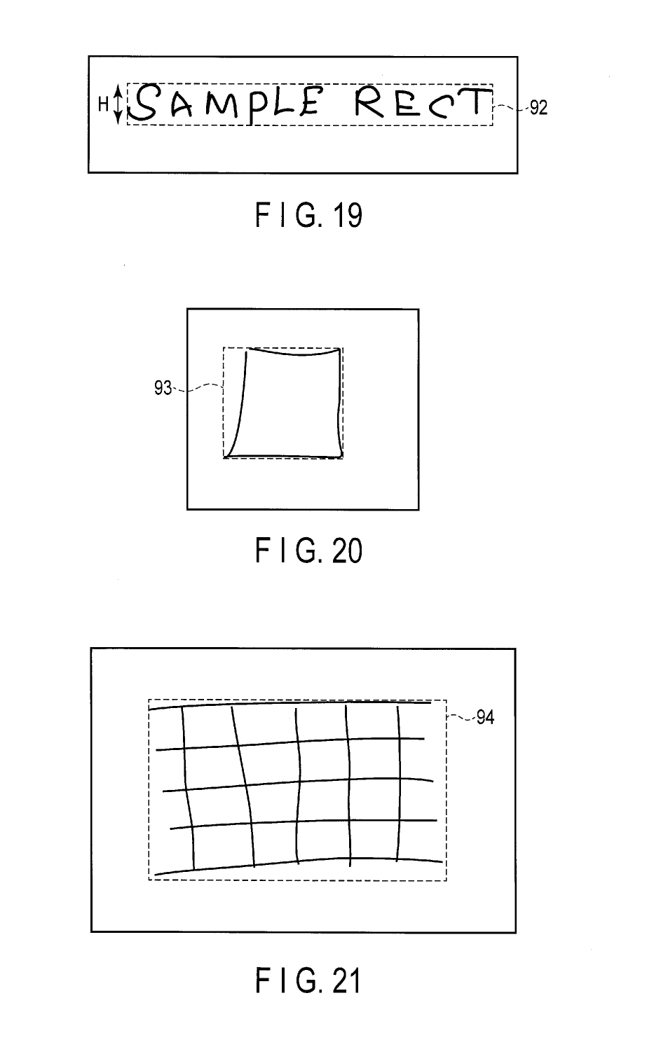

FIG. 19 shows an example of a circumscribed rectangle 92 set for strokes of characters. In character formatting, strokes of characters which are continuous in terms of time or positions are set as a character stroke block. Strokes are processed for each character stroke block. In the example shown in FIG. 19, strokes showing ten characters are continuously input (within a relatively-short time), and the input positions are close to each other. Therefore, the strokes are processed as one character stroke block. The character formatting module determines the size of formatted characters, considering the height H of the circumscribed rectangle 92 set for the character stroke block drawing as the original character size. The height H of the circumscribed rectangle 92 is the maximum height of the character stroke block. Thus, the formatted characters are determined so as to be shorter than the height H.

FIG. 20 shows an example of a circumscribed rectangle 93 set for strokes of a drawing. FIG. 21 shows an example of a circumscribed rectangle 94 set for strokes of a table. The strokes of the table include, for example, a plurality of strokes which are continuous longitudinally and laterally. The strokes of the drawing and table are formatted in accordance with the positions and sizes of the circumscribed rectangles 93 and 94 shown in FIG. 20 and FIG. 21.

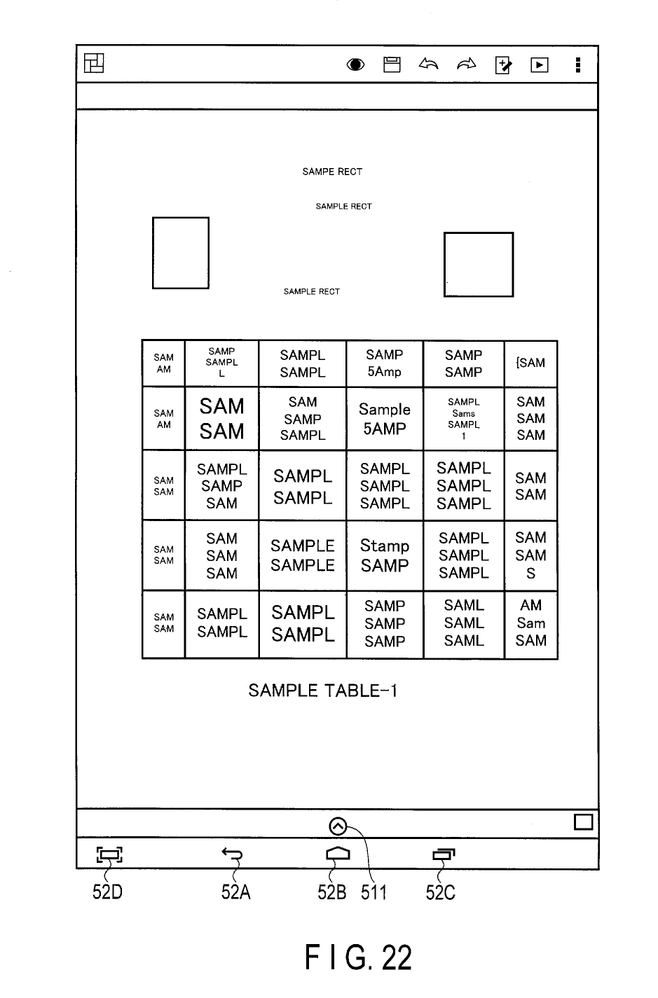

FIG. 22 shows an example of a document obtained by formatting the handwritten document shown in FIG. 10 in the document formatting mode “Variable”.

As shown in FIG. 22, the drawings and the table are formatted with the layout substantially same as the original handwritten document. Characters which are not included in the drawings or table are formatted so as to have a smaller font than the size (height H) of the handwritten characters. Thus, the character strings handwritten above the table in FIG. 22 are small. With regard to the character string handwritten under the table in FIG. 22, they are handwritten obliquely. Therefore, the circumscribed rectangle is large, and thus, the formatted characters are large. With respect to the character strings included in the table, the character size is adjusted for each cell of the table. Thus, the layout of the table is maintained. It is possible to output a drawing or table with a layout similar to that of the original handwritten document by performing document formatting in the formatting mode “Variable”.

When the document formatting mode is “Fixed”, the formatting module of the document formatting module 303 performs a process as shown in the flowchart of FIG. 14. The character formatting module determines the font size of characters in a handwritten document (page) as the fixed font size determined in advance (step C1), adjusts the characters so as to have a font size corresponding to the character size and outputs the characters (step C2). The graphic formatting module determines the size of a drawing or table in accordance with the font size of characters and the number of characters in the area of the drawing or table (step C3). The character formatting module and the graphic formatting module repeatedly apply the above process to all of the character stroke blocks in the handwritten document until the end (steps C1 to C4).

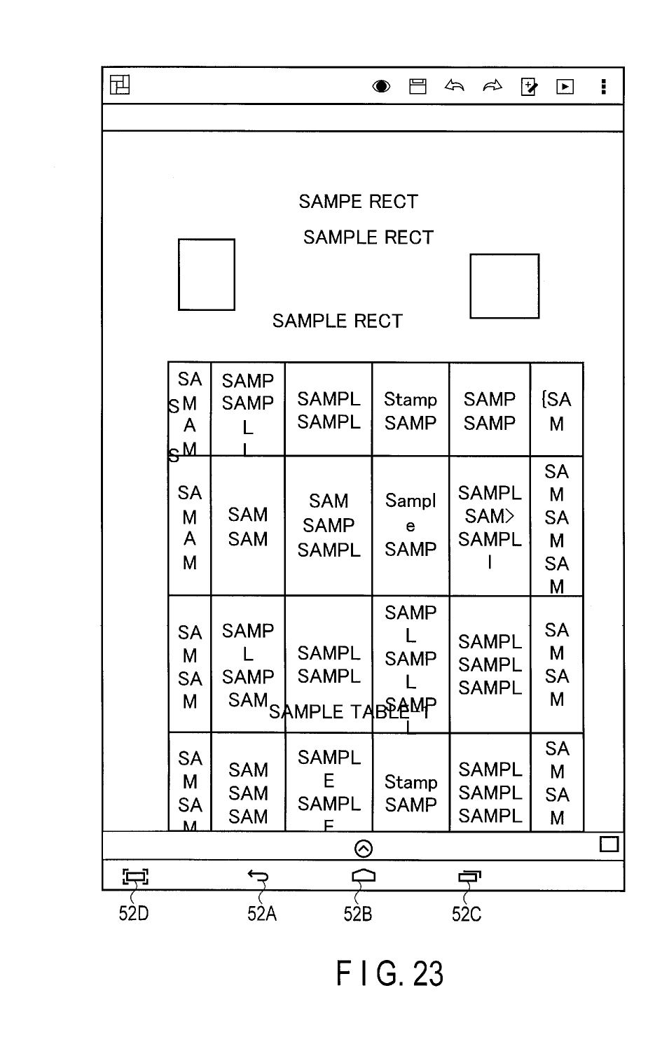

FIG. 23 shows an example of a document obtained by formatting the handwritten document shown in FIG. 10 in the handwritten formatting mode “Fixed”.

As shown in FIG. 23, the size of characters outside the drawings or the table is made uniform. Thus, the handwritten document can be formatted such that characters are easy to read.

When the document formatting mode is “Hybrid 1”, the formatting module of the document formatting module 303 performs a process as shown in the flowchart of FIG. 15. The graphic formatting module converts strokes recognized as a drawing or table by the graphic recognition module into a pattern (the first shape pattern) showing a drawing or table. At this time, the graphic formatting module determines the graphic size in accordance with the original handwritten graphic size (step D1). In other words, the position and the size (layout) of a drawing or table are determined so as not to largely shift the correspondence between the drawing or table in a handwritten document and the drawing or table in a formatted document.

When character strokes are present inside a drawing or table (Yes in step D2), the character formatting module determines the size of formatted characters in accordance with the area size of the drawing or table (step D4) and determines the font size corresponding to the character size (step D5). The font size is automatically adjusted so as to be fit within the drawing or table while the layout of the drawing or table is maintained.

On the other hand, when character strokes are not present inside a drawing or table (No in step D2), the character formatting module determines the size of formatted characters as the fixed font size determined in advance (step D3), adjusts the characters so as to have a font size corresponding to the character size and outputs the characters (step D4). The character formatting module repeatedly applies the above process to all of the character stroke blocks in the handwritten document until the end (steps D2 to D6).

The fixed font size determined in advance is determined corresponding to, for example, the intervals of ruled lines displayed in the area 500 on the page edit screen. The fixed font size is determined as a character size such that formatted characters can be easily read when characters are handwritten based on ruled lines.

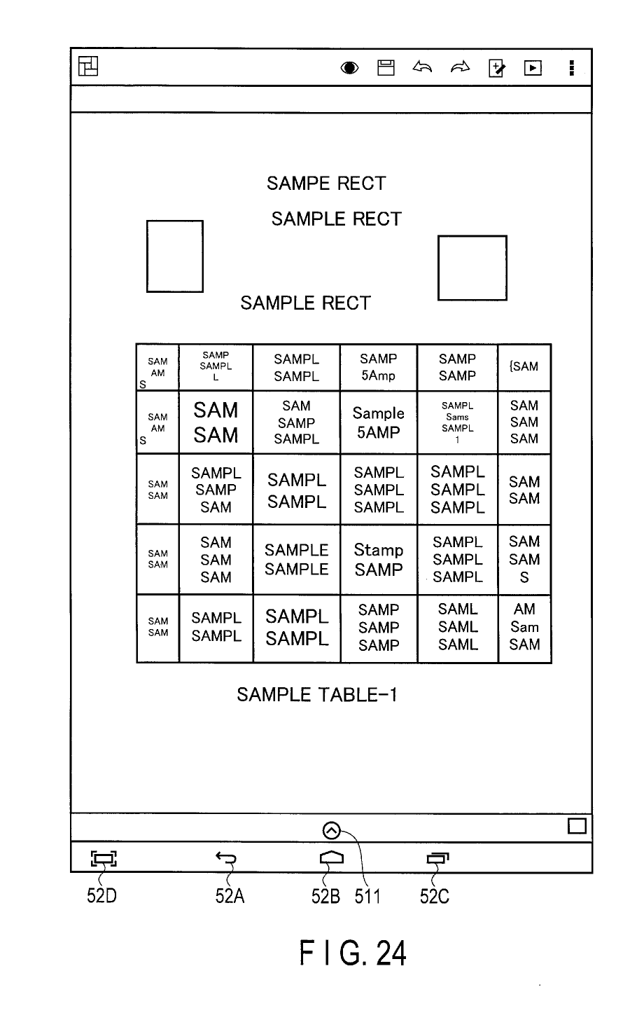

FIG. 24 shows an example of a document obtained by formatting the handwritten document shown in FIG. 10 in the document formatting mode “Hybrid 1”.

As shown in FIG. 24, the drawings and the table can be output with a layout similar to that of the original handwritten document. Further, the document can be formatted so as to be pleasing to the eye by making uniform the size of characters outside the drawings or the table.

In the document formatting mode “Hybrid 1”, the size of characters outside a drawing or table is adjusted to a fixed font size. However, the size of characters outside a drawing or table may be adjusted to a plurality of fixed font sizes. For example, the reference value of the size is set for characters outside a drawing or table in a handwritten document. When the handwritten characters are larger than the reference value in the size, the characters are adjusted so as to have a first fixed font size. When the handwritten characters are smaller than or equal to the reference value in the size, the characters are adjusted so as to have a second fixed font size smaller than the first fixed font size. In this manner, it is possible to make uniform the font size of characters and further reflect the character size of a handwritten document, etc. Furthermore, a document can be formatted with a layout similar to that of the original handwritten document.

When the document formatting mode is “Hybrid 2”, the formatting module of the document formatting module 303 performs a process as shown in the flowchart of FIG. 16. The graphic formatting module converts strokes recognized as a drawing or table by the graphic recognition module into a pattern (the first shape pattern) showing a drawing or table. At this time, the graphic formatting module determines the graphic size in accordance with the original handwritten graphic size (step E1). In other words, the position and the size (layout) of a drawing or table are determined so as not to largely shift the correspondence between the drawing or table in a handwritten document and the drawing or table in a formatted document.

When character strokes are present inside a drawing or table (Yes in step E2), the character formatting module determines the size of formatted characters in accordance with the area size of the drawing or table (step E4). Moreover, when the characters are smaller than the other characters inside the drawing or table in the size, in other words, when the characters are the smallest in the drawing or table in the size, the character formatting module determines the size of all characters in the drawing or table as the smallest character size (step E5) and determines the font size corresponding to the character size (step E6). In short, the size of characters included in the drawing or table is made uniform while the layout of the drawing or table is maintained.

On the other hand, when character strokes are not present in a drawing or table (No in step E2), the character formatting module determines the size of formatted characters as the fixed font size determined in advance (step E3), adjusts the characters so as to have a font size corresponding to the character size and outputs the characters (step E6). The characters inside the drawing or table may be adjusted so as to have a plurality of fixed font sizes in a manner similar to that of the document formatting mode “Hybrid 1”.

The character formatting module repeatedly applies the above process to all of the character stroke blocks in a handwritten document until the en d (steps E2 to E7).

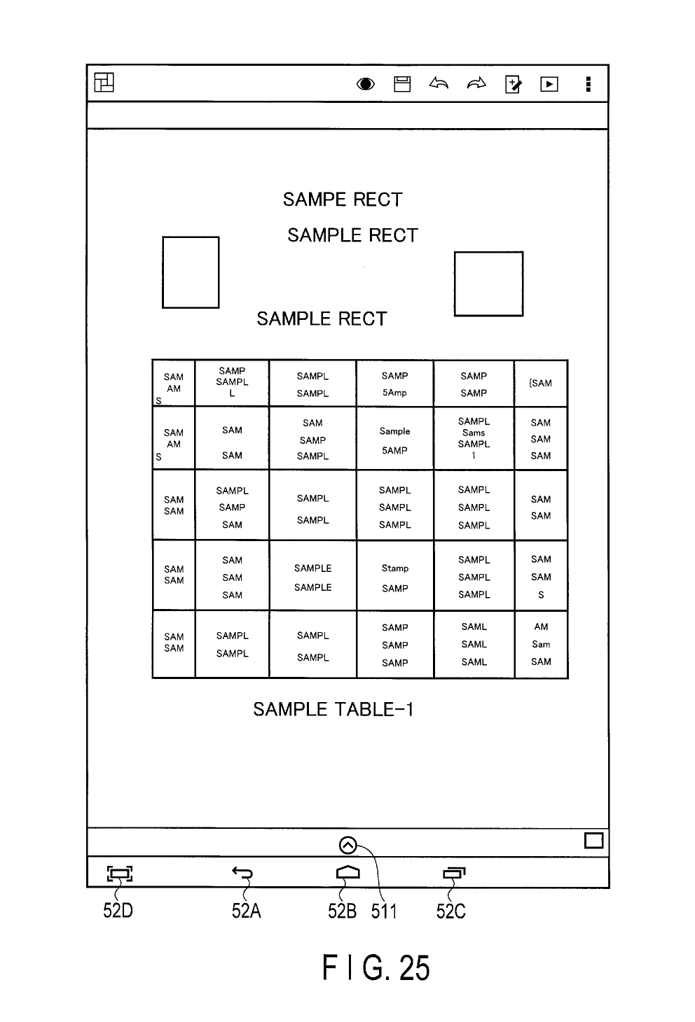

FIG. 25 shows an example of a document obtained by formatting the handwritten document shown in FIG. 10 in the document formatting mode “Hybrid 2”.

As shown in FIG. 25, the drawings and the table can be output with a layout similar to that of the original handwritten document. Further, the document can be formatted so as to be pleasing to the eye by separately making uniform the size of characters outside the drawing or table and the size of characters inside the drawing or table.

In the document formatting mode “Hybrid 2”, the size of all characters inside a drawing or table is made uniform so as to be the smallest character size after formatting. However, the size may not be made uniform so as to be the smallest character size unless the layout of the drawing or table is largely changed. The size may be made uniform by selecting one of character sizes which are within an allowable range after formatting.

Each process of the present embodiment can be realized by a computer program. Therefore, an effect similar to that of the present embodiment can be easily realized by merely installing the computer program into a normal computer through a computer-readable recording medium in which the computer program is stored and executing the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic device comprising:
circuitry configured to:
display handwritten strokes on a screen;
convert a first stroke of the handwritten strokes into a first shape pattern, the first stroke comprising a first feature; and
convert a second stroke of the handwritten strokes into a second shape pattern in an area defined by the first shape pattern, the second stroke comprising a second feature different from the first stroke.

2. The electronic device of claim 1, wherein
the circuitry is configured to convert the second stroke outside the area into the second shape pattern having a preset size.

3. The electronic device of claim 1, wherein
the circuitry is configured to convert the second stroke into the second shape pattern having a size based on the size of the area.

4. The electronic device of claim 1, wherein
the circuitry is configured to convert a plurality of the second strokes within the area into the second shape patterns based on a size of one of the second shape patterns.

5. The electronic device of claim 1, wherein
the circuitry is configured to set a conversion mode indicative of a method of the conversions.

6. A method of converting handwritten strokes comprising:
displaying handwritten strokes on a screen;
converting a first stroke of the handwritten strokes into a first shape pattern, the first stroke comprising a first feature; and
converting a second stroke of the handwritten strokes into a second shape pattern in an area defined by the first shape pattern, the second stroke comprising a second feature different from the first stroke.

7. The method of claim 6, further comprising:
converting the second stroke outside the area into the second shape pattern having a preset size.

8. The method of claim 6, wherein
the converting the second stroke comprises converting the second stroke into the second shape pattern having a size based on the size of the area.

9. The method of claim 6, wherein
the converting the second stroke comprises converting a plurality of second strokes within the area into the second shape patterns based on a size of one of the second shape patterns.

10. The method of claim 6, further comprising:
setting a conversion mode indicative of a method of the conversions.

11. A non-transitory computer-readable storage medium storing a computer program which is executable by a computer, the computer program causing the computer to execute functions of:
displaying handwritten strokes on a screen;
converting a first stroke of the handwritten strokes into a first shape pattern, the first stroke comprising a first feature; and
converting a second stroke of the handwritten strokes into a second shape pattern in an area defined by the first shape pattern, the second stroke comprising a second feature different from the first stroke.

12. The non-transitory computer-readable storage medium of claim 11, further comprising:
converting the second stroke outside the area into the second shape pattern having a preset size.

13. The non-transitory computer-readable storage medium of claim 11, wherein
the converting the second stroke comprises converting the second stroke into the second shape pattern having a size based on the size of the area.

14. The non-transitory computer-readable storage medium of claim 11, wherein
the converting the second stroke comprises converting a plurality of second strokes within the area into the second shape patterns based on a size of one of the second shape patterns.

15. The non-transitory computer-readable storage medium of claim 11, further comprising:
setting a conversion mode indicative of a method of the conversions.
